(19) United States
(12) Patent Application Publication
(10) Pub. No.: US 2019/0368442 A1
(43) Pub. Date: Dec. 5, 2019

(54) Solid Particle Fuel Burner

(71) Applicant: Edward Norbert Endebrock, Lewiston, ID (US)

(72) Inventor: Edward Norbert Endebrock, Lewiston, ID (US)

(21) Appl. No.: 16/405,959

(22) Filed: May 7, 2019

Related U.S. Application Data
(60) Provisional application No. 62/679,001, filed on May 31, 2018.

(51) Int. Cl. F02G 1/043; F23B 30/06

(52) U.S. Cl. CPC F02G 1/043; F02G 2254/10; F23B 2700/037; F23B 30/06

(57) ABSTRACT

A burner for solid particle fuels such as shavings or pellets. The invention includes an auger to deliver fuel particles up an inclined tube into a cup having an oxygen emitting orifice for combustion. The auger is axially extendable and retractable to first advance material up the tube without rotation, and then retract with rotation so as to screw itself into the next charge of material to be advanced. Combustion heat may be used to drive a Stirling engine to comprise a combined heat and power (CHP) system.

Flue gases may also be condensed onto chilled objects as beneficial ceramic-like coatings, or these objects may be made of frangible or soluble material so that the condensate may be collected separately as a valuable ceramic-like material.

### CROSS REFERENCE TO RELATED APPLICATION

This application claims the benefit of priority to U.S. Provisional Application 62/679,001 “Solid Particle Fuel Burner,” filed May 31, 2018. The entire contents of U.S. Provisional Application 62/679,001 “Solid Particle Fuel Burner,” filed May 31, 2018, are hereby incorporated into this document by reference.

### COPYRIGHT STATEMENT

A portion of the disclosure of this patent document contains material that is subject to copyright protection. The copyright owner has no objection to the facsimile reproduction by anyone in the Patent and Trademark Office patent file or records, but otherwise reserves all copyright rights whatsoever.

### FIELD

The invention relates to a burner for solid particle fuels such as shavings or pellets. The invention includes an auger to deliver fuel particles into a cup for combustion. Combustion heat can be used to drive a Stirling engine.

### BACKGROUND

Burners for boilers, external combustion engines, and industrial heating are sometimes designed to consume solid fuel particles such as sawdust, wood chips, fuel pellets, pulverized coal, and other combustible materials. Recent developments have produced bulk fuels from various biomass sources including dead or dried plant matter, aquatic algae, dung, garbage, construction waste, wood or other shavings, shredded paper or plastic, bark, hog fuel, and sawdust from logging and lumber milling operations. Heavy tars and long-chain waste polymers from the petroleum and plastics industries, food waste, animal byproducts, and carcasses can also be processed into combustible forms. Bulk fuel particles can be made from single sources or from combinations of the above sorts or materials, and in some cases composites can be optimized so that an easy burning material can ignite first to pre-heat and ignite a more difficult to burn material with which it has been compounded. Manufacture and compositions of fuel pellets, flakes or particles are outside the scope of the invention. Nevertheless, compared to traditional fossil fuels, using biomass rather than fossil fuels has other advantages including local economic development, waste reduction and the security of a domestic or a regional fuel supply.

Material handling of solid fuel particles such as flakes, shavings or pellets can be challenging especially when the material in bulk is uncompacted or “fluffy.” Consistency in the range of particle size of a bulk solid fuel enables mechanical feed systems to operate at constant speeds and deliver substantially constant or consistent amounts of stored energy over given intervals of time, stabilizing the energy output generated for various industrial processes including boilers, incinerators, power generation, and industrial heating needs.

Since the 19^{th} century, machinery has been developed to transport solid fuels, especially coal, from bulk storage containers to combustion chambers. A familiar example is the auger-fed firebox of a locomotive delivering lumps of coal from a tender. Augers rotating inside tubes have long been used mostly for horizontal transport, but substantial difficulties arise when augers are used to raise material against gravity, either vertically or on an incline.

Moving material upward inside a tube at an inclined angle is more challenging than is usually appreciated. Most successful auger feed mechanisms operate horizontally and some operate at or near vertical. Although some bulk materials can be transported up an incline when an auger is driven like an Archimedes screw, sources of inefficiencies which are not as critical in horizontal or vertical augers are deleteriously combined for an auger operating inside an inclined tube.

Vertical augers must prevent material from slipping below the inlet in the tube, and must also prevent material from simply spinning with the auger inside the tube and not advancing upward.

Augers operating on inclines typically incur losses in conveying efficiency between 30% and 90%. Attempts to reduce these efficiency losses include using reduced pitch screws of ½ or ⅔ the pitch normally used for horizontal or vertical applications, or using larger diameter tubes. Increasing the speed of the screw conveyor is also required, which also means additional horsepower is required to overcome gravity and bulk material fall back. It would be desirable to invent an auger capable of moving material at an inclined angle without having to incur efficiency losses or increased costs of physically larger machinery which required more power to operate.

Higher combustion temperature confers several advantageous: it enables more complete combustion, which means more energy extracted for the cost paid for the fuel and reduced environmental pollution from carbon monoxide, ozone, and the corollary costs of abatement of incomplete combustion products such as hydrocarbons, ash, and volatile organic compounds (VOCs.) Increasing the amount of oxygen in a combustion zone raises the temperature and enables more complete combustion. Pure oxygen or oxygen-enriched gas blends can be delivered to a combustion zone by piping and nozzles, and also by simpler methods such as supplying compressed air, or forced air, or blast air.

Another advantage of operating a burner at high combustion temperatures and in an oxygen enriched atmosphere is that lower quality sources of fuel can be consumed and also some waste products not usually considered as fuels can be burned before disposal, thus extracting useful energy which would otherwise be lost and also reducing bulk and weight of materials to be disposed of.

The challenge presented by high combustion temperature operations is that the physical materials of the machinery itself suffer from accelerated corrosion, erosion, creep, and fatigue compared to lower temperatures. Additional care and design expertise is required for assembly tolerances for close-fitting or mechanically connected or interoperable components subject to cycles of thermal expansions, deformations, and returns to ambient temperatures. Materials which can withstand high temperature service and stresses are often more expensive.

Combined heat and power (CHP) systems are being invented which capture a portion of heat of combustion and convert it to other forms of energy, typically electricity, motive power, or boilers for industrial or chemical processes, or to generate steam for heat or other industrial purposes. CHP systems that provide the benefits of CO2 fertilization have been implemented on industrial scales, and micro-CHP systems are available for home use. However, the majority of these systems use natural gas as their primary source of fuel. The burners in these systems are incapable of processing low-grade solid feedstock effectively.

### BRIEF SUMMARY

A primary objective of the invention is to provide a means of delivering solid fuel particles, flakes, or pellets from a bulk collector such as a hopper, tender, or a bunker to a combustion chamber or a receptacle in proximity to a flame, a heat source, or an ignition source.

Another objective of the invention is to deliver oxygen to a defined combustion zone to raise the combustion temperature and effect cleaner, more complete combustion. A corollary objective of the invention is to extract useful energy from low-grade or low energy density fuels. Another corollary object of the invention is to be able to burn low quality fuels cleanly and with less environmental damage.

Another objective of the invention is to capture a portion of the combustion heat and convert it to other useful forms of energy such as combined heat and power. A corollary objective of the invention is commercially viable CHP system that uses alternative fuel source to provide energy at a cost independent of natural gas prices.

Since the invention can be built to a wider range of size and scale, besides industrial plants, another objective of the invention is to provide a smaller, portable CHP apparatus suitable for temporary use such as camping or to provide emergency residential back-up power and heat during a local or regional disaster, severe weather event, or other condition in which the municipal electrical grid has failed. Another use for a smaller and more portable CHP system is that usable combustible biomass is sometimes generated sporadically or seasonally within a region from activities such as harvesting, depredation, timber cutting, or clearing land for development.

Lastly, some plants actually thrive in air containing smoke and combustion products from burning certain plastics, and especially waste plastics, and thus another objective of the invention since is that the burner can be used to burn such plastic wastes in a combustion process tuned for the development of this particularly beneficial exhaust.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows an external, side view of components comprising the invention.

FIG. 2a shows a partial cutaway view of some of the components of FIG. 1 to expose and illustrate some internal components of the invention, including an auger in a retracted position.

FIG. 2b shows another partial cutaway view but with an auger in an extended position.

FIGS. 3a, 3b, 3c, 3d, and 3e show several types of augers which can be incorporated into various embodiments in accordance with the invention.

FIG. 4 shows an auger in an extended position which although within the scope of the invention, is extended beyond an optimal extended position.

FIG. 5a shows a mechanism for advancing and retracting an auger operating inside an inclined tube in accordance with the invention.

FIG. 5a shows an alternate mechanism for advancing and retracting an auger operating inside an inclined tube in accordance with the invention.

FIG. 6a shows an embodiment of the invention in which the combustion cup includes more than one oxygen delivery tube and nozzle.

FIG. 6b shows an embodiment of the invention in which the oxygen delivery nozzle has a plurality of orifices.

FIG. 7 shows a stylized combined heat and power (CHP) system including co-generation and precipitation of useful ceramic materials from flue gas.

### DETAILED DESCRIPTION of CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The invention is an apparatus for oxygen-enriched burning, comprising an auger at an inclined angle to deliver fuel particles to a combustion zone. Heat developed from combustion can be used for boiling, generating steam for heat or motive power or both, or applied to a heat engine such as a Stirling cycle engine. Pressure swing adsorption is used to separate oxygen from the air and feed it into the burner to achieve a hotter flame temperature that provides more complete burning and reduced pollutant production compared with alternative systems. Oxygen-enriched combustion has been shown to improve burner efficiency and lower fuel consumption input by as much as 10 percent for a given thermal requirement, while simultaneously reducing NOₓ emissions by 90 percent.

The introduction of oxygen into the cup of the burner of the invention creates an atmosphere in the spaces between the fuel particles which is typically around 85% oxygen, and combustion temperatures in excess of 4000° F. and sometimes in excess of 4500° F. Thus in the combustion zone there will be little or no NOx compounds created. All other materials are oxidized and are exhausted as gases. The gas delivered by the oxygen delivery tube comprises at least 85% pure oxygen, and the oxygen in the gas can be concentrated to at least 85% by means of pressure swing adsorption. However, oxygen enrichment to at least 50% is sufficient to operate the invention and to achieve its benefits in at least some limited degrees.

The oxygen-enriched burner of the invention enables such extremely clean burning that the burner can be used inside green houses, a use which has high market potential, including greenhouse lighting and heating. When burning plastic pellets, the carbon dioxide and the water vapor released are prime products for produce grown in hydroponic greenhouses. Heat can be captured in water basins so as to maintain a constant temperature in a hydroponic growing area. The carbon dioxide released allows plants to excel in growth. Electricity can be produced directly from the burner by the use of Sterling engine technology. This electricity would then be used for grow lights at night and for control circuits.

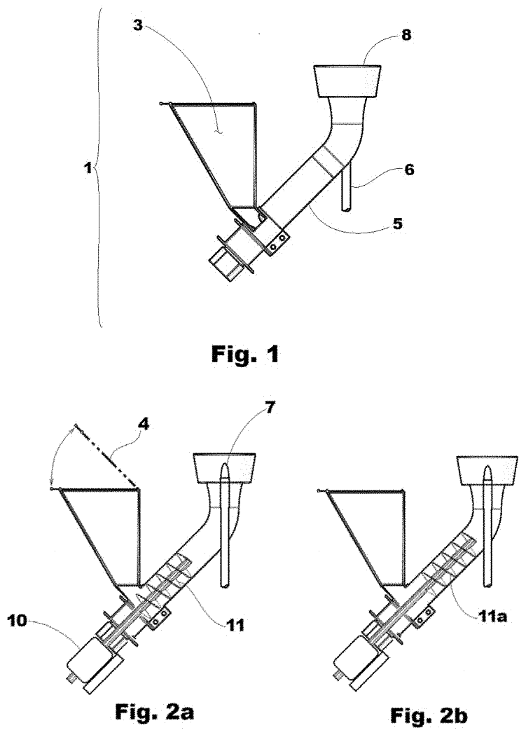

Referring now to the figures, FIG. 1 shows an external, side view of components comprising the invention, being an assembly [1] comprising a hopper [3,] a fuel feed tube [5] having a lumen oriented at an inclined angle, an oxygen delivery tube [6,] and a combustion cup [7.] The lumen or inner passage of the fuel feed tub communicates with the combustion cup. The invention will work for fuel feed tubes operating at inclined angles between 30° and 75° inclusive, and a best mode configuration has the inclined angle of the tube at about 45°, or between 40° and 50° inclusive.

FIG. 2a shows a partial cutaway view of some of the components of FIG. 1 to expose and illustrate some internal components of the invention, including an auger in a retracted position. The hopper is equipped with a hinged lid [4] and disposed within the lumen of the inclined fuel feed tube is an extendable auger [11] driven by a motor [10] operably coupled to it for rotation thereof. In this figure the auger is shown in a retracted position. The oxygen delivery tube has a nozzle [7] or tip having at least one orifice. Flame propagates from burning fuel particles to charges of new fuel particles forced into the bottom of the cup by the auger. (‘New’ in this context of the specification refers to fuel particles not yet ignited and entering the combustion cup as driven by the auger.) Fuel particles are displaced radially outwards within the cup as new particles are fed from below. Burning fuel particles which are pushed out of the cup continue to burn within the combustion chamber, and continue to contribute to the energy available for heat and power. FIG. 2b shows the auger in an extended position [11a.] The auger is thus rotatably and slidably coupled to the fuel feed tube.

Although oxygen may be provided from any source, a best mode operation of the invention includes collecting or generating oxygen by pressure swing adsorption (PSA) or vacuum pressure swing adsorption (VSA.) These processes operate on regular air and at more or less ambient temperatures rather than cryogenic processes. In the process nitrogen is sequestered from air while allowing gaseous oxygen to pass through, thus concentrating the oxygen content of the remaining gas volume to about 85%, which is roughly 4½ times the oxygen content of air. After the concentration phase, a backflow phase removes the sequestered nitrogen from the adsorptive material to prepare for the next concentration phase. The nitrogen can be collected for other industrial processes. Further details of these oxygen concentration processes are beyond the scope of the invention.

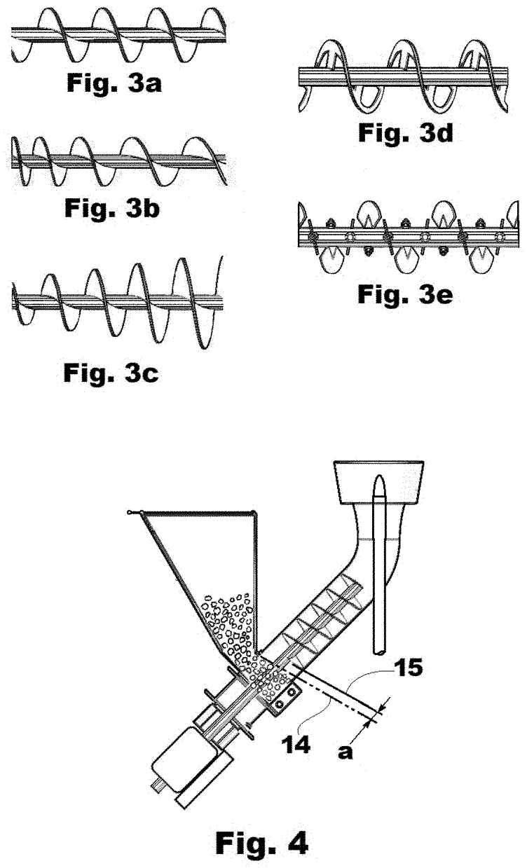

FIGS. 3a, 3b, 3c, 3d, and 3e show several types of augers which can be incorporated into various embodiments in accordance with the invention. FIG. 3a shows a conventional auger having a constant pitch and screw diameter along an axial direction. FIG. 3b shows a variable pitch auger having a constant diameter along an axial direction but an increasing pitch along that axial direction. FIG. 3c shows a tapered auger having an increasing diameter along axial direction. The tapered auger may also be constructed with a variable pitch. A tapered auger operates inside a conical hopper, a funnel, or a tapering tube such as a nozzle. FIG. 3d shows a ribbon auger in which only the perimeter of the screw is a continuous membrane. This sort of auger can be used with fuel particles which can be moved in bulk even when only a portion of the particles are in contact with and impelled by the auger ribbon. A similar design to the ribbon auger is a crescent auger in which the ribbon is not continuous but comprises a punctuated series of arc segments affixed by posts to the central shaft of the auger. FIG. 3e shows a paddle auger in which an array of axially spaced and radially spaced paddles extend from attachment points along the auger shaft. The angle of the paddles is adjustable so that a constant pitch or variable pitch configuration can be assembled.

However, when the auger extends without rotation in accordance with the invention, it pushes a charge of fuel particles up the tube without the hinderances encountered by an axially stationary auger rotating within an inclined tube. In contrast the invention only rotates the auger while it slides axially to its retracted position. The rate of retraction is matched to the pitch of the auger so that particles within the swept volume of the auger remain substantially stationary. They may jostle or reorient themselves, but as a whole they neither advance up the tube nor fall back with the retracting auger. Essentially the auger is screwing itself downward into a substantially stationary volume of particles.

When the auger extends again to push a charge of new fuel particles into the combustion cup, a volume of particles drop from the hopper into the tube behind the augur. As is seen in FIG. 4, extending the auger too far up the tube past the hopper would leave a void behind the augur which could begin to fill up with particles falling in from the bottom end of the auger. Raising material with one operation only to have it fall and be raised again by a second operation contributes to cyclic inefficiency and wasted motion. In FIG. 4, the material which falls into the tube from the hopper assumes an angle of repose represented by the phantom line [14.] For a given material, the optimum angle of incline for the fuel feed tube would be perpendicular to the angle of repose of the fuel particles. However, other physical constraints or standards may require some other tube angle such as 45°. If the auger is pushed too far up the tube, the bottom of its swept volume [15] departs from the angle of repose of incoming material from the hopper. In this illustration the excess excursion of the auger is the distance “a” as shown. Best mode operation of the invention occurs when distance “a” is zero or at least minimized.

The intermittent rotation of the auger may effected by highly controllable motors operably coupled to it, such as a stepper motor, or mechanical means may be used to intermittently engage the auger shaft to a conventional motor spinning at a steady speed. Since conventional motors are much less costly and less complex to operate, the mechanical means may be more practical despite its additional components. A pair of separated spur gears, one on the auger shaft and the other on the motor shaft, may be intermittently driven by periodically interposing an idler gear so that the pitch diameter of the idler touches the pitch diameters of the other two spur gears. Although motion and power may begin to transfer from the motor to the auger as soon as the addendum diameter of the idler contacts the addenda of the two spur gears, gear tooth stresses are minimized and smooth, reliable rotation occurs when the idler teeth fully engage the teeth of both other gears.

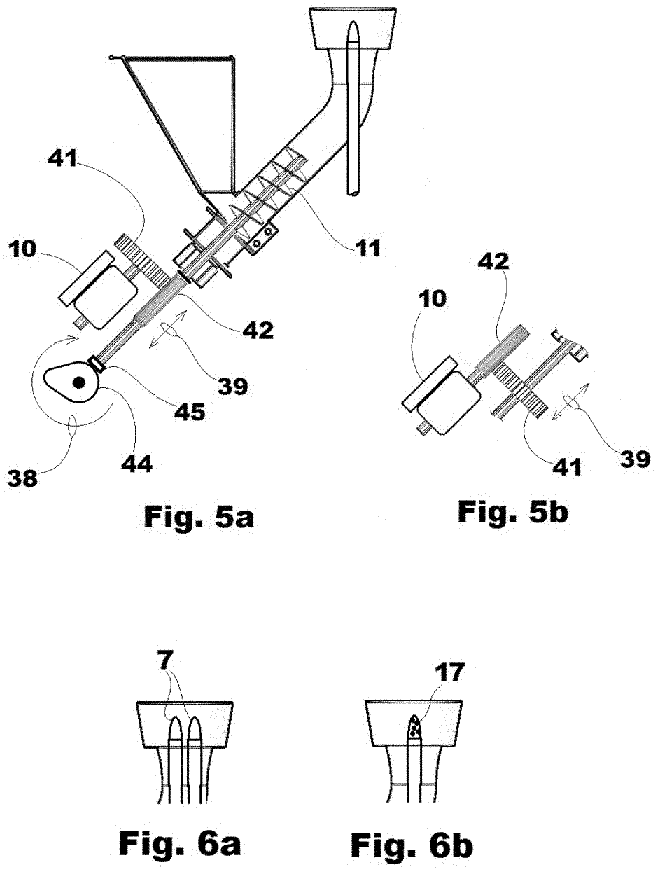

The components shown in FIGS. 5a and 5b are stylized representations rather than realistic renderings. Although not as sophisticated as using stepper motors, FIG. 5a shows a simple cam and cam follower mechanism within the scope of the invention. The reciprocating auger [11] of the invention is moved between an extended position and a retracted position by means of a cam [44] and cam follower [45] mechanism. The auger is both slidably coupled and rotatably coupled with respect to the feed tube, and reciprocating motion of the auger is represented by double-headed arrow [39.] The auger includes a spline section [42] engaged with a driving gear [41] which is usually an involute spur gear but may be any kind of gear or toothed wheel to engage with the splines of the auger. The splines may be cut into the auger shaft as longitudinal grooves or may be raised from the shaft as a radial array of teeth extending in a longitudinal direction along the auger shaft. The driving gear is affixed onto the spindle or driveshaft of a motor [10.]

Although the cam follower [45] may remain in contact with the cam [44] by gravity and the weight of the auger, at higher operating speeds the cam may offer a retracting motion which is faster than the freefall velocity of the auger after accounting for friction between the auger and fuel particles and inner surface of the fuel feed tube. In the case the auger may be spring-loaded in an axial direction to maintain a minimum effective preload of the cam follower onto the cam surface and to accelerate the auger axially so that at maximum operating speed, no gap occurs between the cam and the cam follower.

FIG. 5b shows a subset of these components in an alternate arrangement within the scope of the invention, in which the motor [10] is provided with a splined shaft [42] which engages a spur gear or toothed wheel [41] mounted on the auger shaft. Reciprocating motion [39] of the auger slides the gear along the splines so that positive rotary motion may be imparted from the motor to the auger at its extended or retracted position and at any point between.

Preferably, the motor is run intermittently, and is held at a stop except while the auger is moving downward from its extended position to its retracted position. During the downward motion, the motor rotates the auger at a predetermined rate so that, given its helical pitch, material in the inclined section of the tube remains substantially stationary during its downward or retracting motion. Although the cam [44] of FIG. 5a is shown having a single lobe or nose, an elliptical cam may also be used wherein one rotation of the cam produces two excursions of the auger. A disc with an offset hole, or any other ovoid may be used which imparts the desired reciprocating motion to the auger. Most cam profiles will move the auger at non-linear velocities during the course of cam rotation. When a stepper motor is used for the motor [10,] a programmable controller may vary the motor shaft speed so that even with cams that lower the auger at non-linear velocities, the auger may rotate at a corresponding non-linear angular velocity complementary to the helical pitch of the auger blade. Thus, during descent the material in the inclined section of the tube remains substantially stationary as the auger screws itself into stationary material below.

The upstroke of the auger pushes fresh fuel particles into the combustion cup from the center of its bottom so to introduce a charge of unburned material into the cup. Since this material is cooler than the burning material, cooling of cup and the other burner components is effected by heat transfer from the hot components into the fresh charge of fuel particles as they arrive in the cup. This heat transfer extends the service life of the burner components by cooling them, and also serves to preheat the fuel particles before they ignite.

Besides the cam and cam follower mechanism described above, other means exist for sliding the auger between a retracted position and an extended position within the lumen of the fuel feed tube. For example, the auger may be moved by a solenoid exerting electromagnetic force as a linear actuator. Hydraulic or pneumatic cylinders may also be used. Where these components cannot withstand heat within the immediate vicinity of the burner, they may be placed outside the combustion chamber and operably connected to the auger by push rods or control cables connected to a bell crank adapted to convert linear motions or control cable motions into the desired extension and retraction motions for the auger.

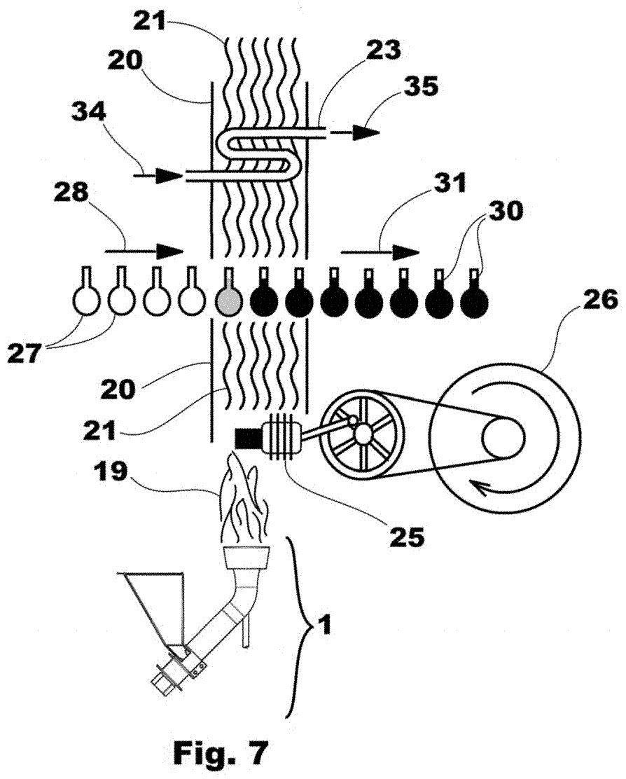

Many different configurations or types of oxygen delivery tubes may be used in accordance with the invention. FIG. 6a shows an embodiment of the invention in which the combustion cup includes more than one oxygen delivery tube and nozzle. These may be arranged in a radial array within the combustion cup or in other configurations. FIG. 6b shows an embodiment of the invention in which the oxygen delivery nozzle has a plurality of orifices to direct incoming oxygen to all regions within the combustion cup. Of course, more than one such multiple-orifice nozzle or tip may be incorporated into the combustion cup. A combustion cup in accordance with the invention includes a perimeter wall for retaining charges of solid fuel particles within the immediate vicinity of the oxygen delivery nozzle.

For startup, the auger and fuel particle feed system is run until fuel particles fill the combustion cup. Then oxygen is turned on, and an ignition source is provided. Once oxygen is present leaving the orifice or nozzle at the tip of the oxygen delivery tube, a simple lit match may be dropped into the cup as an ignition source, and fuel combustion begins. Other ignition sources within the scope of the invention include electric arcing across a spark gap, or resistive wire such as nichrome wire heated by electric current to attain an ignition temperature. With the 85% oxygen concentration as delivered, combustion take place at approximately 4500° F. The residual ash at this temperature vaporizes.

Certain volatile compounds and other materials vaporize in the presence of this flame temperature, even though they do not react or break down. They pass on through to the exhaust or flue gas, where they may be optionally condensed on to chilled plates or other chilled articles introduced into the flue at a point where the flue structure preferably remains heated above the solidification point of these materials. The materials condense and solidify onto the chilled items passed through the flue gas, and for fuel particles made from waste plastics, wood, and most other biomass this precipitate resembles a ceramic and will be called “ceramic precipitate” in this specification. The chilled items may be selected so as to benefit from a coating of ceramic precipitate as an industrial coating or surface treatment of the items passed through the flue gas, or items may benefit from the ornamentality of the coating, like glazed pottery. Furthermore, if it is desired to collect the ceramic precipitate alone for other uses, the chilled items may be created from frangible or cancellous material, or materials subject to dissolution in a solvent which does not affect the ceramic precipitate.

The items, after receiving a coating of ceramic precipitate, may be crushed or dissolved in solvent to separate the materials comprising the items from the ceramic precipitate by other means such as mechanical, electrical, or magnetic separation techniques. A solvent may be provided which dissolves the items but does not dissolve the ceramic precipitate, thus by dissolving the item a user of the invention may separate it from the ceramic precipitate. Like the nitrogen extracted by the pressure swing adsorption process described above, the ceramic precipitate may be sold as a byproduct of this combined heat and power process.

FIG. 7 shows a stylized combined heat and power (CHP) system including co-generation and precipitation of useful ceramic materials from flue gas. The burner [1] produces heat and flames [19] and flue gas [21] which is lead through a stack or funnel. The flame is first applied to the hot-side cylinder head of an air-cycle engine [25] such as a Stirling or Essex cycle hot air engine, or any heat engine that operates by cyclic compression and expansion of air or other working fluid at different temperatures, such that there is a net conversion of heat energy to mechanical work represented here as a rotating load [26] driven by the engine. The load may be a generator or alternator or belt driven machinery or the like.

Next, a conveying system carries chilled items into the flue [27] in an ingress direction indicated by arrow [28.] The chilled items accrue a ceramic precipitate as described above. Coated items [30] leave the flue following an egress direction indicated by arrow [31.]

Lastly in the figure, additional waste heat may be recovered using an intercooler [23] in the flue. A working fluid having low enthalpy (thermodynamic energy) enters the intercooler at an ingress [34] and acquires heat from the flue gas. The working fluid leaves the intercooler at an egress [35] in an energetic, higher enthalpy state. The recovered energy in the working fluid, such as its heat, pressure or velocity, may be transferred to other machinery for providing additional benefits such as space heating, heat for cooking or industrial processes, or mechanical power. If the working fluid enters as a liquid and leaves as a vapor, the intercooler functions as a flash boiler and the energetic vapor may be expanded through a turbine to provide mechanical power or to generate electricity. A particularly efficient and low-cost turbine is the Tesla-style stacked disc turbine which has an advantage of being able to extract enough heat energy to partially condense the working fluid into droplets without incurring the kind of damage that droplets typically wreak inside a conventional bladed turbine.

Also, military activities such as timber work for the creation of breastworks, fortifications, obstacles, or camouflage, or defoliation or destruction of natural cover or concealment, or destruction of enemy structures or supplies made from organic materials, may also generate waste biomass which available to be fed into a field portable CHP system to provide energy and heat in support of an operation.

While certain features and aspects have been described with respect to exemplary embodiments, one skilled in the art will recognize that numerous modifications are possible. Further, while various methods and processes described herein may be described with respect to particular structural and/or functional components for ease of description, methods provided by various embodiments are not limited to any particular structural and/or functional architecture.

Hence, while various embodiments are described with or without certain features for ease of description and to illustrate exemplary aspects of those embodiments, the various components and/or features described herein with respect to a particular embodiment may be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. An apparatus for oxygen-enriched burning, comprising
a combustion cup having a floor and a perimeter wall having a rim,
an oxygen delivery tube communicating with said combustion cup,
a fuel feed tube having a lumen oriented at an inclined angle between 30° and 75° inclusive, said lumen communicating with said combustion cup,
an auger deposed within said lumen, said auger rotatably coupled to and slidably coupled to said fuel feed tube,
a motor operably coupled to said auger for rotation thereof, and
means for sliding said auger between a retracted position and an extended position.

2. The apparatus of claim 1, wherein said auger further comprises a cam follower in contact with a cam.

3. The apparatus of claim 1, wherein said inclined angle is between 40° and 50° inclusive.

4. The apparatus of claim 1, wherein said motor is a stepper motor.

5. The apparatus of claim 1, wherein a shaft of said motor further comprises splines.

6. The apparatus of claim 1, wherein said auger further comprises splines.

7. A combined heat and power system, comprising
an apparatus for oxygen-enriched burning further comprising
a combustion cup having a floor and a perimeter wall having a rim,
an oxygen delivery tube communicating with said combustion cup,
a fuel feed tube having a lumen oriented at an inclined angle between 30° and 75° inclusive, and said lumen communicating with said combustion cup,
an auger deposed within said lumen, said auger rotatably coupled to and slidably coupled to said fuel feed tube,
a motor operably coupled to said auger for rotation thereof, and
means for sliding said auger between a retracted position and an extended position, and
an air-cycle engine.

8. The combined heat and power system of claim 8, wherein said oxygen delivery tube contains a gas comprising at least 50% oxygen.

9. The combined heat and power system of claim 8, wherein said air-cycle engine is a Stirling cycle engine.

10. The combined heat and power system of claim 8, further comprising an intercooler.

11. A method for collecting a ceramic precipitate from flue gas, comprising the steps of:
a. providing an apparatus for oxygen-enriched burning of solid particulate fuel, comprising
a fuel feed tube having a lumen oriented at an inclined angle between 30° and 75° inclusive, and said lumen communicating with said combustion cup,
an auger deposed within said lumen, said auger rotatably coupled to and slidably coupled to said fuel feed tube,
a motor operably coupled to said auger for rotation thereof, and
means for sliding said auger between a retracted position and an extended position, and
b. providing solid particulate fuel, a gas comprising at least 85% oxygen, and an ignition source to begin combustion,
c. burning said solid particulate fuel at combustion temperature exceeding 4000° F. and producing flue gas thereby,
d. providing chilled items to be coated,
e. passing said chilled items through said flue gas, and
f. allowing a ceramic precipitate to accrue onto a surface of at least one of said chilled items.

12. The process of claim 11, further comprising the steps of:
g. crushing said item, and
h. separating a ceramic precipitate from the materials comprising said item.

13. The process of claim 11, further comprising the steps of:
g. providing a solvent which dissolves said item but does not dissolve said ceramic precipitate, and
h. dissolving said item to separate it from said ceramic precipitate.

14. The process of claim 11, further comprising a step ‘a1’ before step ‘b’ of:
a1. collecting oxygen by means of a pressure swing adsorption apparatus.

15. The process of claim 11, wherein said solid particulate fuel comprises a biomass selected from the set of biomasses consisting of
sawdust, wood chips, pulverized coal, dead plant matter, dried plant matter, aquatic algae, dung, garbage, construction waste, wood shavings, shredded paper, shredded plastic, bark, hog fuel, tar, long-chain waste polymers, food waste, animal byproducts, and animal carcasses.
